(19) United States
(12) Patent Application Publication
(10) Pub. No.: US 2017/0310938 A1
(43) Pub. Date: Oct. 26, 2017

(54) PROJECTION DISPLAY APPARATUS AND PROJECTION DISPLAY SYSTEM

(71) Applicant: CANON KABUSHIKI KAISHA, Tokyo (JP)

(72) Inventor: Takahiro Okamura, Utsunomiya-shi (JP)

(21) Appl. No.: 15/493,207

(22) Filed: Apr. 21, 2017

(30) Foreign Application Priority Data
Apr. 25, 2016 (JP) 2016-087221
Apr. 28, 2016 (JP) 2016-090851

(51) Int. Cl. H04N 9/31

(52) U.S. Cl. CPC H04N 9/3188; H04N 9/315

(57) ABSTRACT

A projection display apparatus includes an image inputter configured to input image data, a signal processor configured to perform a gradation conversion for the image data, and a luminance calculator configured to calculate a luminance of a projection image in accordance with a projection state. The signal processor converts a gradation of the image data so as to reduce a difference between a luminance of the projection image and a luminance required by the image data.

### BACKGROUND OF THE INVENTION

### Field of the Invention

The present invention relates to a projection display apparatus that can project an HDR image.

### Description of the Related Art

According to the conventional image signal standard Rec. 709 generally used for a display apparatus, the dynamic range of the image is adjusted to the display apparatus when the standard is determined, and the maximum luminance on the image is normalized to 100 nits (cd/m²). As the luminance on the image increases due to the progress of the display unit, the standard cannot catch up with the performance of the display unit and becomes insufficient as the dynamic range standard. Accordingly, the standardization of a signal format called a high dynamic range (“HDR”) with an extended dynamic range has been demanded.

Japanese Patent No. 5,723,008 discloses a method for extending a dynamic range of an image. Japanese Patent Laid-Open No. 2013-85182 discloses a method for correcting an image so that the luminance of a projected image by a plurality of projection display apparatuses can be equivalent to that of the original image.

However, a system configuration becomes complicated and it is difficult to improve the HDR image quality in order to realize the methods (HDR controls) disclosed in Japanese Patent No. 5723008 and Japanese Patent Laid-Open No. 2013-85182.

### SUMMARY OF THE INVENTION

The present invention provides a projection display apparatus and a projection display system, each of which can improve the quality of an HDR image with a simple configuration.

A projection display apparatus according to one aspect of the present invention includes an image inputter configured to input image data, a signal processor configured to perform a gradation conversion for the image data, and a luminance calculator configured to calculate a luminance of a projection image in accordance with a projection state. The signal processor converts a gradation of the image data so as to reduce a difference between a luminance of the projection image and a luminance required by the image data.

Further features of the present invention will become apparent from the following description of exemplary embodiments with reference to the attached drawings.

### BRIEF DESCRIPTION OF THE DRAWINGS

FIG. 1 is a block diagram of a projection display apparatus according to a first embodiment.

FIG. 2 is a flowchart of HDR gradation conversion processing according to the first embodiment.

FIGS. 3A to 3C are graphs illustrating the gradation conversion processing based on a projection plane luminance according to the first embodiment.

FIG. 4 is a block diagram of a projection display apparatus according to a second embodiment.

FIG. 5 is a block diagram of a projection display apparatus according to a third embodiment.

FIG. 6 is a flowchart of HDR gradation conversion processing according to the third embodiment.

FIGS. 7A to 7E are graphs illustrating the gradation conversion processing based on a projection plane luminance according to the third embodiment.

FIG. 8 is a block diagram of a projection display apparatus according to a fourth embodiment.

FIG. 9 is a flowchart of a control method according to the fourth embodiment (for acquiring a stack luminance and for rewriting EDID).

FIGS. 10A to 10E are graphs illustrating a correlation between a luminance and image data according to the fourth embodiment.

FIG. 11 is a block diagram of a projection display system according to a fifth embodiment.

FIG. 12 is a flowchart of a control method according to the fifth embodiment (for acquiring a stack luminance and for rewriting EDID).

### DESCRIPTION OF THE EMBODIMENTS

Referring now to the accompanying drawings, a description will be given of embodiments of the present invention.

### First Embodiment

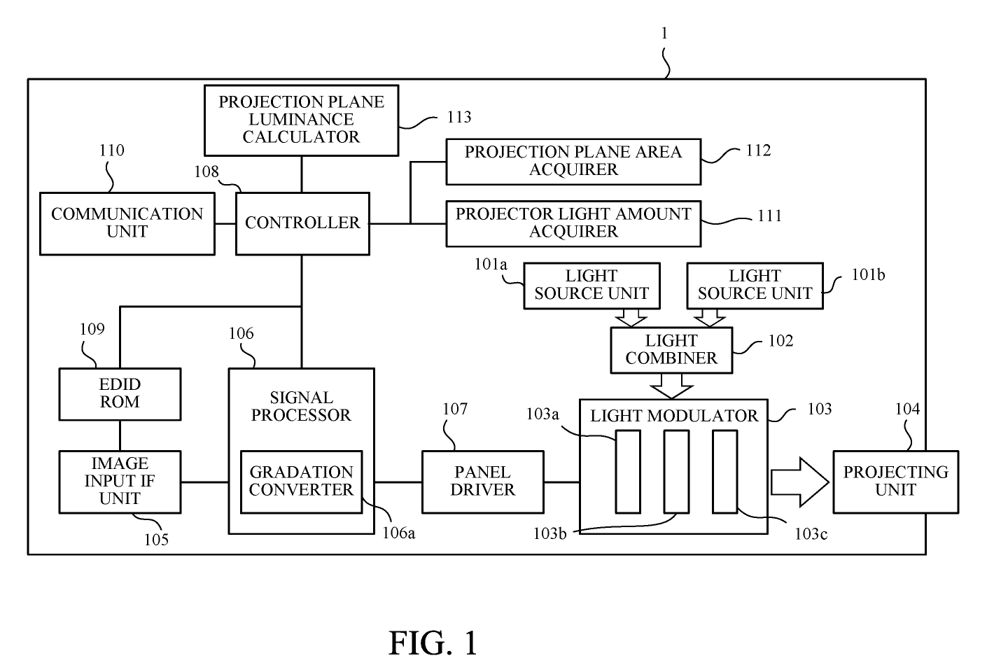

Referring now to FIG. 1, a description will be given of a projector (projection display apparatus) according to a first embodiment of the present invention. FIG. 1 is a block diagram of a projector 1 according to this embodiment.

The projector 1 includes light source units 101a and 101b each includes a light source). The projector 1 includes two light source units 101a and 101b in this embodiment, but may include three or more light source units. The light source may use a discharge lamp, such as an ultrahigh pressure mercury lamp. Of course, this embodiment is not limited to this embodiment, and may use a light source other than the discharge lamp, such as a laser or another solid-state light source.

Light emitted from each of the light source units 101a and 101b is combined by the light combiner 102. The light combiner 102 includes a variety of optical elements, such as a mirror, a prism, and a lens. The light combined by the light combiner 102 enters the light modulator 103.

The light modulator 103 includes a color separating optical system 103a, liquid crystal panels (or three light modulation elements) 103b, and a light combining optical system 103c. The color separating optical system 103a separates the light (white light) from the light combiner 102 into three RGB color light fluxes (R light flux, G light flux, and B light flux). The liquid crystal panel 103b modulates each of the three color light fluxes. The color combining optical system 103c combines the three color light fluxes that are modulated by the three liquid crystal panels 103b, with one another. In this configuration, the light modulator 103 modulates the input light or an image based on a drive signal input from the signal processor 106. In this embodiment, the light modulator may use a digital micro mirror device (“DMD”) instead of the liquid crystal panel 103b. In this case, the R light flux, the G light flux, and the B light flux sequentially extracted from the white light from the light combiner 102 by the color filters sequentially enters one DMD and are modulated. The light modulator 103 includes an unillustrated drive circuit configured to drive the light modulation element, such as a liquid crystal panel and a DMD, based on the drive signal input from the signal processor 106.

The light or image modulated by the light modulator 103 is projected on an unillustrated projection plane, such as a screen, via the projecting unit 104 (projection lens) that includes an optical system, such as a lens and a mirror. The projecting unit 104 is integrated with the projector 1 or interchangeably attached to the projector 1.

An image input interface (“IF”) unit (image inputter) 105 includes an interface that receives an image signal (HDR image data, such as HDMI® and SDI) corresponding to the HDR from the outside of the projector 1, and transmits it to the signal processor 106. Thereafter, the image input IF unit 105 can receive metadata containing information on the HDR. For example, in HDMI2.0a, the information on the HDR of the image data input via INFOFRAME can be obtained.

The signal processor 106 receives the image data input via the cable from the outside of the projector 1 or via the image input IF unit 105 through the wireless communication. The signal processor 106 provides a variety of processes, such as a decode process of the image signal, a keystone correction of the image signal, image processing (e.g., scaling) for the image signal, and a process for superimposing an on-screen display (“OSD”) image on the image signal. The signal processor 106 includes a gradation converter 106a configured to perform a gradation process (gradation conversion processing) for the HDR image. The signal processor 106 outputs the processed image signal to a panel driver 107. The panel driver 107 drives the liquid crystal panel 103a by generating the drive signal corresponding to the received image signal.

A controller 108 includes a microcomputer (processor), and controls each component in the projector 1 in accordance with a control program as a computer program.

An EDIDROM (storage unit) 109 stores information on EDID (extended display identification data), such as a type and a resolution (display capacity) of the projector 1, in other words, information on the projector 1. The EDIDROM 109 is connected to the image output unit, such as a PC and a blue-ray recorder, via the image input IF unit 105. The image output device determines the contents of the image to be output by reading data stored in the EDIDROM 109. The data (EDID) stored in the EDIDROM 109 contains information on the HDR.

A communication unit 110 enables communications between the external device and the projector 1. The communication unit 110 may use, but is not limited to, RS232C, IR remote controller, USB, Ethernet®, WiFi, etc. The signal received by the communication unit 110 enters the controller 108, and is utilized for a variety of controls by the controller 108.

A projector light amount acquirer 111 acquires a light amount of the projector 1. The light amount of the projector 1 can be obtained by storing a lumen (light flux) as a unit usually used to estimate the brightness of the projector 1, as a setting value for the specification of the projector 1. A more precise setting value is available by storing a setting value in each projector 1 based on actual measurement data before the projector 1 is shipped. The light source generally lowers the brightness with working time, and may use a value that reflects a change of the light flux after the projector 1 is shipped, based on a relationship between the light source working time period and the light source deterioration (which is calculated based on the calculation equation and the experimental data). A photo-diode configured to measure leak light may be provided around the light combiner 102, the light modulator 103, and the projecting unit 104, and a value of the light flux may be calculated based on the relationship between the leak light and the light flux (or calculated based on the calculation equation and the experimental data).

A projection plane area acquirer 112 acquires the area (projected area) on the projection plane of the projection image output from the projector 1. The projection plane area acquirer 112 includes, for example, an illustrated distance sensor and an unillustrated encoder. The projection plane area acquirer 112 measures a distance from the projector 1 to the projection plane using the distance sensor, and measures a zoom state of the projector 1 using the encoder. The projection plane area acquirer 112 compares the measurement result with the previously stored distance to zoom reference (size reference), and can calculate the area of the projection image or projected area. For example, assume that the reference indicates that the distance from the projection plane is 5 m, a zoom state is a wide-angle end, and the projection plane has an area of 100 inches times 100 inches. When the zoom state is maintained and the distance becomes half, the projection plane has an area of 50 inches times 50 inches. In case of the interchangeable lens type projector, the information on the reference can be previously stored in a memory in the interchangeable lens, and the information of the area may be obtained based on the information read out of the memory.

A projection plane luminance calculator 113 (luminance calculator) calculates the luminance (projection plane luminance) based on the light amount of the projector 1 obtained by the projector light amount acquirer 111 and the projection plane area of the projection image of the projector 1 obtained by the projection plane area acquirer 112. The projection plane luminance calculator 113 may calculate the luminance in accordance with the projection state (lighting states of a plurality of light sources). For example, the controller 108 transmits the light amount (projector light flux) of the projector 1 obtained by the projection light amount acquirer 111, and the projection plane area obtained by the projection plane area acquirer 112, to the projection plane luminance calculator 113. The projection plane luminance calculator 113 calculates the projection plane luminance based on a relational expression between the projector light amount and the projection plane area (projector light amount/projection plane area/Π), and sends it to the controller 108. This relational expression may contain other parameters, such as a reflectance of the projection plane.

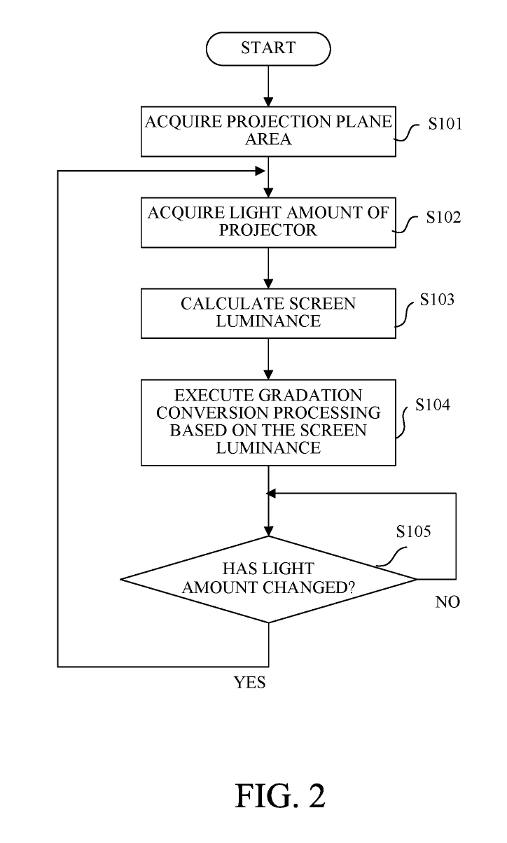

Referring now to FIG. 2, a description will be given of a control method by the projector 1 according to this embodiment (or a method for gradation conversion processing for the HDR by calculating the projection plane luminance). FIG. 2 is a flowchart of the gradation conversion processing for the HDR. Each step in FIG. 2 is executed mainly by a command of the controller 108 in the projector 1.

Initially, in the step S101, the controller 108 controls the projection plane area acquirer 112 and acquires the projection plane area. Next, in the step S102, the controller 108 controls the projector light amount acquirer 111 and acquires the projector light amount (light amount of the projector 1). Next, in the step S103, the controller 108 transmits the projection plane area obtained in the step S101, and the projection light amount obtained in the step S102, to the projection plane luminance calculator 113. The controller 108 controls the projection plane luminance calculator 113, and obtains the calculation result of the projection plane luminance (screen luminance).

Next, in the step S104, the controller 108 transmits the calculation result of the projection plane luminance (screen luminance) obtained by the projection plane luminance calculator 113, to the gradation converter 106a. The gradation converter 106a performs the gradation conversion processing for the HDR based on the calculation result of the obtained projection plane luminance. In other words, the gradation converter 106a changes the gradation conversion processing for the input image data (HDR image data) based on the projection plane luminance.

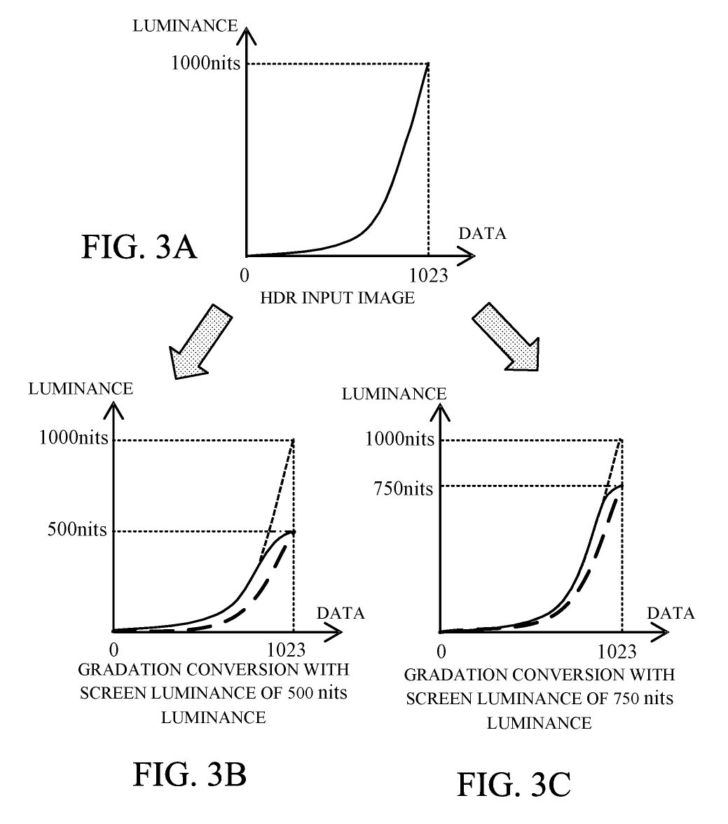

Referring now to FIGS. 3A to 3C, a description will be given of the gradation conversion processing for the HDR based on the projection plane luminance. FIGS. 3A to 3C are graphs illustrating the gradation conversion processing based on the projection plane luminance, and the relationship between the gradation and the brightness of the HDR image. Each abscissa axis in FIGS. 3A to 3C denotes a value of the image data (HDR image data) from 0 to 1023 with 10 bits. Each ordinate axis in FIGS. 3A to 3C denotes the luminance (brightness). This relationship is referred to as EOTF (electro-optical transfer function) and the relational expression corresponding to the input signal standard is determined. The EOTF for the HDR is known as a relational expression referred to as a PQ curve. The graph illustrated in FIG. 3A illustrates an input image (input image, image data) representative of the brightness of the maximum 1000 nits (cd/m²) with 10 bits, for example. This relational expression is determined by the standard of the input signal and usually received by metadata contained in the input.

FIG. 3B illustrates a graph when one of the light source units 101a and 101b in the projector 1 is lit on. Herein, FIG. 3B illustrates image data by a solid line obtained through the gradation conversion processing where the maximum luminance on the image is calculated as 500 nits and only one of the light source units 101a and 101b is lit on. FIG. 3B illustrates the input image (input signal) illustrated in FIG. 3A by a dotted line. FIG. 3B illustrates the input signal by a broken line when the input image (input signal) in FIG. 3A is displayed on the projector of 500 nits simply (without corrections).

The dotted-line image data (input signal) requires 1000 nits, but the maximum luminance that can be actually output is limited to 500 nits. Thus, when the input image in FIG. 3A is not corrected, the entire image becomes dark, as illustrated by the broken line in FIG. 3B. Accordingly, as illustrated by the solid line in FIG. 3B, this embodiment converts the gradation such that when the gradation is equal to or lower than a predetermined gradation, the input image is equivalent to that with the maximum luminance of 1000 nits, and when the gradation is higher than the predetermined gradation, the input image is rounded or corrected. Since the human eyes are sensitive to the low gradation, this embodiment provides a correction such that the low gradation data is equivalent to the data with 1000 nits.

When the dotted-line input data has the maximum value of 1023 bits, this embodiment rounds it to 500 nits as illustrated by the solid line in FIG. 3B although it is originally 1000 nits. If the image data is not rounded, the image data equal to or higher than the predetermined gradation is saturated as illustrated by an alternate long and short dash line in FIG. 3B (and becomes constant with 500 nits). In order to avoid the saturation, the image data equal to or higher than the predetermined gradation is rounded as illustrated by the solid line (or the image data equal to or higher than the predetermined gradation is approximated by a predetermined curve or predetermined function). Since the human eyes are sensitive to the low gradation, the low gradation data is maintained and the relationship between the high gradation data and the luminance is changed.

FIG. 3C is a graph when both the light source units 101a and 101b are lit on in the projector 1. FIG. 3C illustrates image data by a solid line, which is obtained with the gradation conversion processing when the maximum luminance on the image is calculated as 750 nits. FIG. 3C illustrates input image (input signal) illustrated in FIG. 3A by a dotted line. FIG. 3C illustrates, by a broken line, input image illustrated in FIG. 3A uncorrected and displayed on the projector with 750 nits. FIG. 3C illustrates a saturated state (that is constant with 750 nits) by an alternate long and short dash line when the image data is not rounded. Since the image data illustrated by the solid line in FIG. 3C approaches to the maximum luminance of the original input image data, and the relationship between the high gradation image data and the luminance is less likely to change than that in FIG. 3B. The gradation conversion processing illustrated in FIGS. 3A to 3C are merely illustrative, and the conversion method between the input image data and the output image data may be another method.

In the step S105 in FIG. 2, the controller 108 monitors a change of the projector light amount. When the controller 108 detects a change of the light amount, the flow returns to the step S102. The steps S102 to S105 are repeated, and the controller 108 performs gradation conversion processing suitable for the changed light amount. On the other hand, when the controller 108 does not detect a change of light amount, the controller 108 repeats the step S105 until it detects a change of the light amount. The light amount changes due to a change of the lamp supplied power, a light source deterioration with time and its working environment, a change of an image processing method caused by a change of an imaging mode, etc. (which will be collectively referred to as “a change of a projection state”). Thus, this embodiment is applicable to a projector that includes only one light source unit. This embodiment is applicable to a light amount change due to reasons other than the above reasons.

Thus, according to this embodiment, the projector 1 may include a plurality of light sources (light source units 101a and 101b). The projection plane luminance calculator 113 may calculate the luminance of the projection image (projected plane luminance) according to the lighting state (projection state) of each of the plurality of light source units. The projector 1 may include an area acquirer configured to acquire a projected area of the projection image (projection plane area acquirer 112), and a light amount acquirer (projector light amount acquirer 111) configured to acquire a light amount of the projector 1. The luminance calculator calculates a luminance of the projection image based on the projected area obtained by the area acquirer and a light amount obtained by the light amount acquirer.

This embodiment can appropriately control, based on the luminance on the image, the gradation conversion processing for the HDR in the projector that includes a plurality of light source units. Thus, when the projection state changes, the gradation conversion processing for the HDR image can be made closer to the input image.

### Second Embodiment

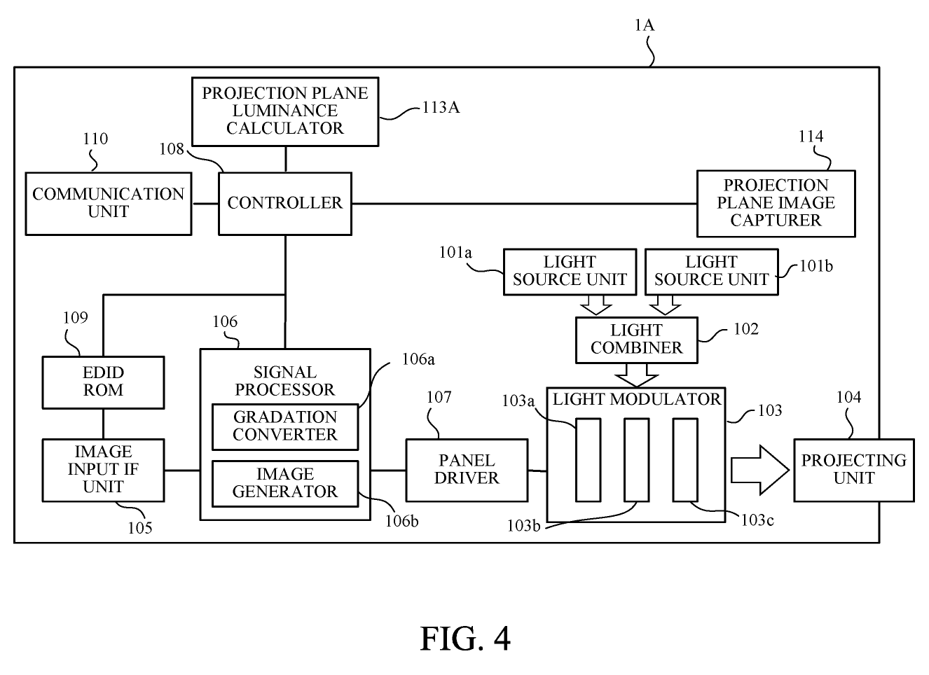

Referring now to FIG. 4, a description will be given of a projector (projection display apparatus) according to a second embodiment of the present invention. FIG. 4 is a block diagram of the projector 1A according to this embodiment. Those elements in this embodiment, which are corresponding elements in the first embodiment (FIG. 1), will be designated by the same reference numerals and a description thereof will be omitted.

This embodiment in which a projection plane luminance calculator 113A calculates the luminance (projection plane luminance) based on the image (projection plane image) captured by a projection plane image capturer 114 is different from the first embodiment in which the projection plane luminance calculator 113 calculates the luminance based on the projection plane area and the projector light amount. In this embodiment, the projection plane image capturer 114 (light amount measuring unit or image capturer) captures an image projected on the projection plane by the projector 1A. This embodiment is not limited to this example, and may use a result measured by another light amount measuring unit, such as a light detector, instead of the projection plane image capturer 114.

The signal processor 106 according to this embodiment includes an image generator 106b in addition to the gradation converter 106a. The image generator 106b generates an image used to determine a light amount when the projection plane image capturer 114 captures an image of a projection plane. For example, the image generator 106b can output a whole white image and capture an image of the projection plane with a maximum light amount, and output a whole black image and capture an image of the projection plane with a minimum light amount.

The projection plane luminance calculator 113A obtains (calculates) the luminance (projection plane luminance) based on the image captured by the projection plane image capturer 114. The projection plane luminance calculator 113A previously stores, for example, correlation data (or a correlation data list) between a data value of the image data obtained by the projection plane image capturer 114 and a luminance value corresponding to the data value. The projection plane luminance calculator 113A can compare the obtained image data with the correlation data list and calculate the luminance value. The correlation data list may use data that reflects the imaging condition of the projection plane image capturer 114, the luminance of the environmental light, etc. When the correlation data can be expressed as a specific expression, the correlation data may be stored as an equation and the luminance may be calculated based on the data value obtained from the image data and the equation. When the projection plane luminance calculator 113A calculates the projection plane luminance, the gradation converter 106a provides the gradation conversion processing for the HDR based on the calculated projection plane luminance, similar to the step S104 in the first embodiment.

Thus, in this embodiment, the projector 1A includes the image generator 106b, the light amount measuring unit (projection plane image capturer 114), and the luminance calculator (projection plane luminance calculator 113A). The image generator generates an image used to determine the light amount of the projector 1A. The light amount measuring unit measures a light amount of the projector 1A based on the image generated by the image generator and projected. The luminance calculator calculates the luminance (projection plane luminance) of the projection image based on the light amount of the projector 1A measured by the light amount measuring unit. The light amount measuring unit may be an image capturer (projection plane image capturer 114) configured to capture an image generated by the image generator and projected.

Similar to the first embodiment, this embodiment can appropriately control, based on the luminance on the image, the gradation conversion processing for the HDR of the projector that includes a plurality of light source units. Thus, when the projection state changes, the gradation conversion processing for the HDR image can be made closer to the input image.

### Third Embodiment

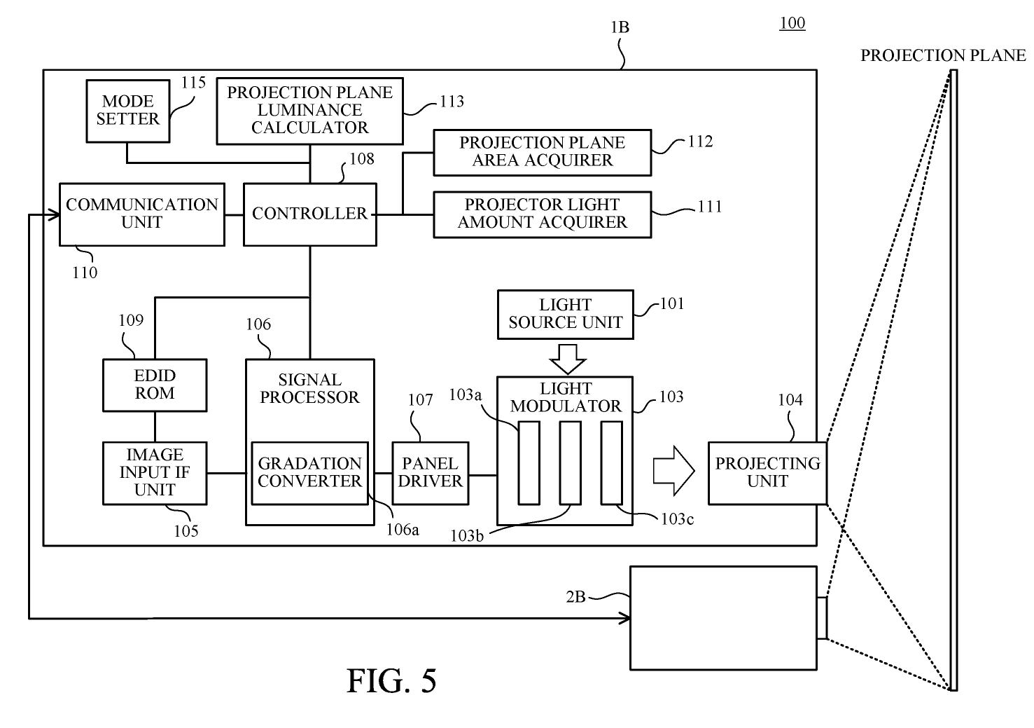

Referring now to FIG. 5, a description will be given of a projector system (projection display system) according to a third embodiment of the present invention. FIG. 5 is a block diagram of a projector system 100 according to this embodiment. Those elements in this embodiment, which are corresponding elements in the projector 1 according to the first embodiment (FIG. 1), will be designated by the same reference numerals and a description thereof will be omitted.

The projector system 100 includes a projector 1B (first projection display apparatus), and a projector 2B (second projection display apparatus). The projectors 1B and 2B have the same configurations, but may have different configurations. The projector system 100 according to this embodiment may include the projectors 1B and 2B in a stack state, and project images.

The projector 1B includes a light source unit 101 (one light source unit) that includes a light source, but may include a plurality of light source units, similar to the first embodiment. A mode setter 115 sets either a stack projection mode or a normal projection mode. A user may set a projection mode, for example, via a user interface, such as GUI. The mode setter 115 may automatically set the stack projection mode by detecting the overlapping projectors (a stack arrangement) with a sensor, characteristic to the stack projection mode.

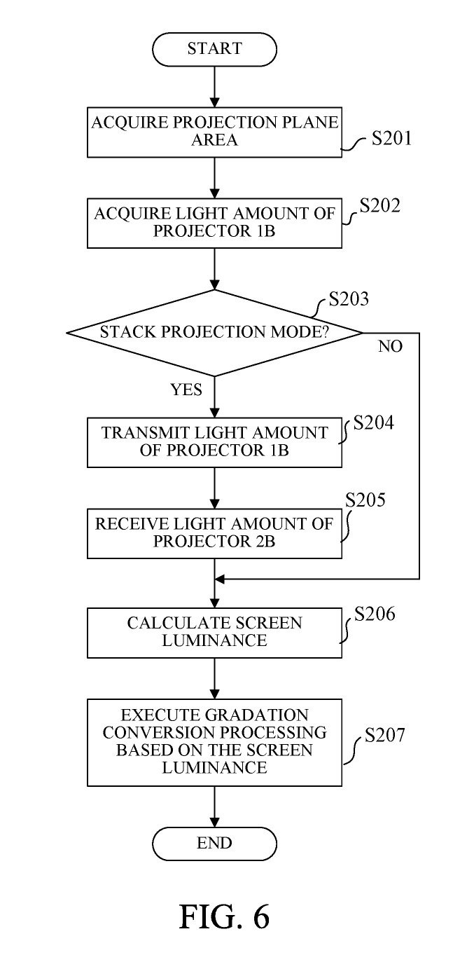

Referring now to FIG. 6, a description will be given of a control method by the projector 1B (projector system 100) according to this embodiment (method for performing gradation conversion processing for the HDR by calculating the projection plane luminance). FIG. 6 is a flowchart of the gradation conversion processing for the HDR. Each step in FIG. 6 is mainly executed by each component based on a command of the controller 108 in the projector 1B.

Initially, in the step S201, the controller 108 controls the projection plane area acquirer 112 and obtains the projection plane area. Next, in the step S202, the controller 108 controls the projector light amount acquirer 111 and obtains the projector light amount (light amount of the projector 1B). Next, in the step S203, the controller 108 receives from the mode setter 115 information on whether the projection mode set by the mode setter 115 is the stack projection mode. When the projection mode is set to the stack projection mode, the flow moves to the step S204. On the other hand, when the projection mode is not set to the stack projection mode, the flow moves to the step S206.

In the step S204, the controller 108 transmits, via the communication unit 110, the projector light amount obtained in the step S202 to the projector 2B (another projector) set to the stack projection mode, similar to the projector 1B. Next, in the step S205, the controller 108 receives the projector light amount (light amount of the projector 2B) via the communication unit 110 via the projector 2B. The user may set the light amount of the projector 2B via the user interface.

Next, in the step S206 from the step S203, the controller 108 transmits the light amount of only the projector 1B to the projection plane area to the projection plane luminance calculator 113. The controller 108 controls the projection plane luminance calculator 113, and obtains the calculated result of the projection plane luminance. In the step S206 from the step S205, the controller 108 transmits both the light amounts and the projection plane areas of the projectors 1B and 2B to the projection plane luminance calculator 113. The controller 108 controls the projection plane luminance calculator 113 and obtains the calculated result of the projection plane luminance.

Next, in the step S207, the controller 108 transmits the calculation result of the projection plane luminance (screen luminance) obtained by the projection plane luminance calculator 113, to the gradation converter 106a. The gradation converter 106a performs the gradation conversion processing for the HDR based on the obtained or calculated result of the projection plane luminance.

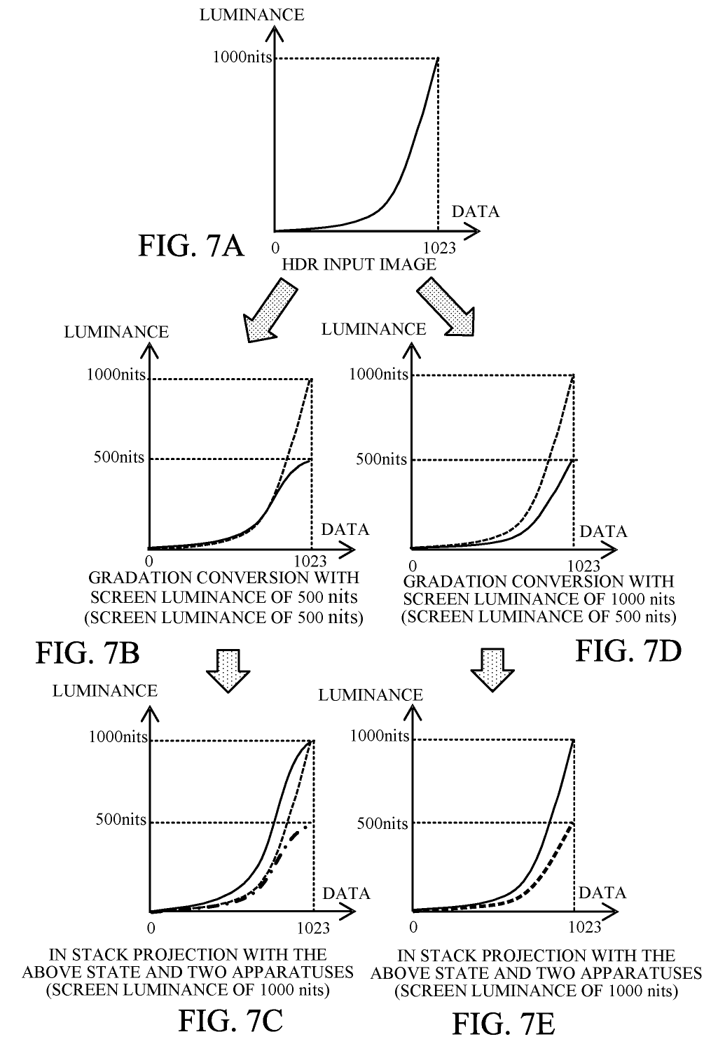

Referring now to FIGS. 7A to 7E, a description will be given of the gradation conversion processing for the HDR based on the projection plane luminance. FIGS. 7A to 7E illustrate graphs of the gradation conversion processing based on the projection plane luminance, and a relationship between the gradation and the brightness of the HDR image. In FIGS. 7A to 7E, each abscissa axis denotes a value of the image data (HDR image data) and each ordinate axis denotes the luminance (brightness).

A graph in FIG. 7A illustrates an input image (image data) with a maximum luminance of 1000 nits (cd/m²) at 10 bits (1023). A graph in FIG. 7B illustrates gradation conversion processing in the projector 1B in a non-stack projection mode. The projection plane luminance is set to 500 nits when only one projector 1B is used for the projection, and the image data obtained by the gradation conversion processing similar to the graph in FIG. 3B is illustrated by the solid line. In addition, FIG. 7B illustrates the input image (input image) illustrated in FIG. 7A by a broken line. FIG. 7C illustrates the image data by a solid line, which is obtained by the gradation conversion processing in the stack projection with the two projectors 1B and 2B in the state of FIG. 7B. The projection plane luminance in this stack projection is 1000 nits. Thus, when the stack projection approximates the image data is approximated as illustrated by an alternate long and short dash line in FIG. 7C (corresponding to the solid line in FIG. 7B), the gradation of the image data that has received the gradation conversion processing deviates from the gradation of the input image as illustrated by the solid line in FIG. 7C.

A graph in FIG. 7D illustrates the gradation conversion processing of the projection 1B when the projection plane luminance of the entire stack projection follows the flowchart in FIG. 6 using the projector system 100 in FIG. 5. FIG. 7D illustrates image data by a solid line when only one projector 1B is used in the stack projection. FIG. 7D illustrates, by a broken line, an input image (input signal) illustrated in FIG. 7A. When only one projection 1B is used for the gradation conversion processing in the stack projection, the image data further deviates from the input image data (input signal) than that in the graph in FIG. 7B (solid line in FIG. 7B).

FIG. 7E illustrates the image data by a solid line in the stack projection with the two projectors 1B and 2B in the state illustrated in FIG. 7D. FIG. 7E illustrates the image data (corresponding to the solid line in FIG. 7D) by a broken line when only one projector 1B is used in the stack projection. Even if the gradation deviates from that of the input image when only one projector 1B is used, the stack projection using the two projectors 1B and 2B (illustrated by the solid line in FIG. 7E) can properly reproduce the HDR input image in FIG. 7A (illustrated by the solid line in FIG. 7A). In other words, when the luminance of the projection image is equal to or higher than the luminance required by the image data, the gradation conversion processing is performed without correcting the image data. The gradation conversion processing is performed such that the luminance required by the image data can be the luminance of the projection image.

This embodiment equally treats a plurality of projectors (projectors 1B and 2B) used in the stack state, but is not limited to this example. For example, the projectors in the stack state may be set to a master projector and a slave projector and the light amount and the luminance may be communicated among them. In this embodiment, the projection plane luminance calculator 113 calculates the projection plane luminance based on the information from the projection plane area acquirer 112 and the projection light amount acquirer 111, similar to the first embodiment. However, this embodiment is not limited to this example. For example, the projection plane luminance calculator 113 may calculate the projection plane luminance based on the information from the projection plane image capturer 114, similar to the second embodiment.

In this embodiment, the projector system 100 (projection display system) configured to project an image using a plurality of projectors (projection display apparatuses) includes a projector 1B (first projection display apparatus) and a projector 2B (second projection display apparatus or another projection display apparatus). The luminance calculator (projection plane luminance calculator 113) calculates the luminance of the projection image obtained with a combination of the projector 1B (projection display apparatus) and the projector 2B (other projection display apparatus).

The luminance calculator may calculate the luminance of the projection image obtained with the combination of the projection display apparatus and the other projection display apparatus based on the area obtained by the area acquirer and the light amount of the other projection display apparatus. The luminance calculator may calculate the luminance of the projection image obtained with the combination of the projection display apparatus and the other projection display apparatus based on the light amount of the projection display apparatus and the light amount of the other projection display apparatus measured by the light amount measuring apparatus. The light amount measuring unit may be an image capturer configured to capture an image generated by the image generator.

This embodiment can appropriately control, based on the luminance on the image, the gradation conversion processing for the HDR in the projector in the stack projection. Thus, when the projection state changes, the gradation conversion processing for the HDR image can be made closer to the input image.

According to the first to third embodiments, the projection display apparatus includes the image inputter (image input IF unit 105), the signal processor 106, and the luminance calculator (projection plane luminance calculator 113). The image inputter inputs image data (HDR image data). The signal processor performs the gradation conversion processing for the image data. The luminance calculator calculates the luminance of the projection image. The signal processor changes the gradation conversion processing for the image data based on the luminance calculated by the luminance calculator.

The image inputter may input the image data (HDR image data) corresponding to the HDR image. The signal processor may perform the gradation conversion processing for the image data so as to approach to the luminance required by the image data when the gradation is equal to or lower than the predetermined gradation and when the luminance of the projection image is lower than the luminance required by the image data.

The first to third embodiment can provide the projection display apparatus and the projection display system, which can improve the quality of the HDR image with a simple configuration.

The present invention is not limited to these embodiments, and various variations and modifications may be made without departing from the scope of the present invention.

For example, when the user can set the luminance obtained from the outside through a menu, the luminance on the image can become more precise. A separate luminance measuring apparatus may communicate the measurement result with the projector.

### Fourth Embodiment

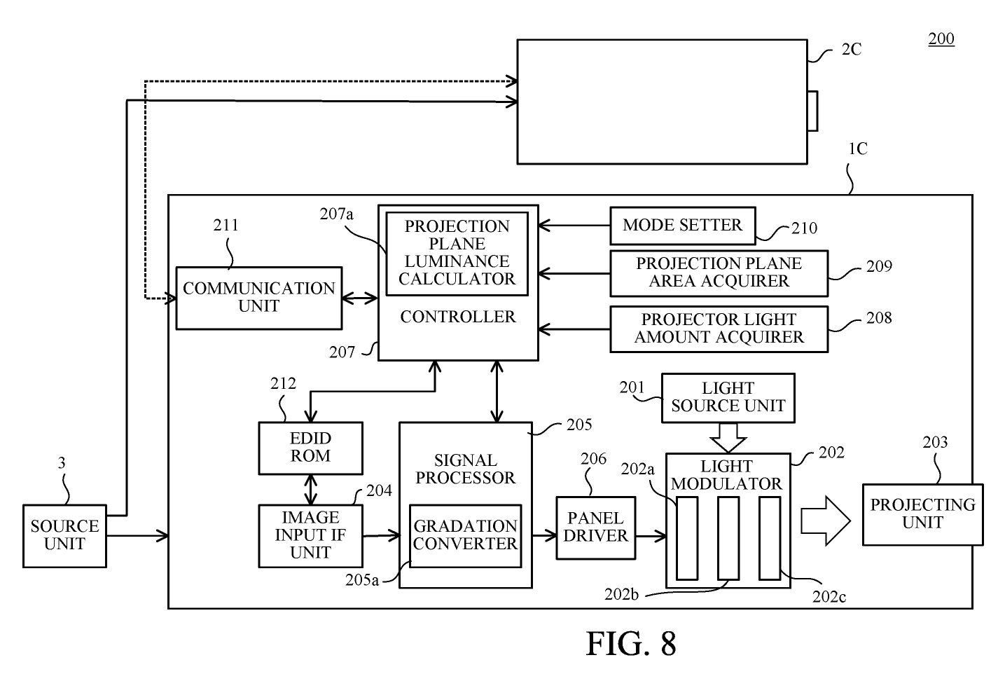

Referring now to FIG. 8, a description will be given of a projector system (projection display system) according to a fourth embodiment of the present invention. FIG. 8 is a block diagram of a projector system 200 according to this embodiment.

The projector system 200 includes a projector 1C (first projector or first projection display apparatus), a projector 2C (second projector or second projection display apparatus), and a source device 3. The projectors 1C and 2C may have the same configurations or different configurations. In this embodiment, the projector system 200 includes the projectors 1C and 2C in a stack state, and can project images.

The projector 1C includes a light source unit 201 that includes a light source. The light source may use a discharge lamp, such as an ultrahigh pressure mercury lamp. This embodiment is not limited to this example, and may use a light source other than the discharge lamp, such as a solid-state light source, such as a laser. The light emitted from the light source unit 201 enters a light modulator 202.

The light modulator 202 includes a color separating optical system 102a, liquid crystal panels (or three light modulation elements) 202b, and a light combining optical system 202c. The color separating optical system 202a separates the light (white light) from the light source unit 201 into three RGB color light fluxes (R light flux, G light flux, and B light flux). The liquid crystal panel 202a modulates each of the three color light fluxes. The color combining optical system 202c combines the three light fluxes modulated by the three liquid crystal panel 202b with one another. In this configuration, the light modulator 202 modulates the input light or an image based on a drive signal input from the signal processor 205. In this embodiment, the light modulation element may use a digital micro mirror device (“DMD”) instead of the liquid crystal panel 202a. In this case, the R light flux, the G light flux, and the B light flux sequentially extracted from the white light from the light source unit 201 by a color filter sequentially enters one DMD and modulates an image. The light modulator 202 includes an unillustrated drive circuit configured to drive the light modulation element, such as a liquid crystal panel and a DMD, based on the drive signal input from the signal processor 205.

The light or image modulated by the light modulator 202 is projected on an unillustrated projection plane, such as a screen, via the projection unit 203 (projection lens) that includes an optical system, such as a lens and a mirror. The projection unit 203 is integrated with the projector 1C or interchangeably attached to the projector 1C.

The input IF unit 204 (image inputter) includes an interface that receives an image signal (HDR image data, such as HDMI® and SDI) corresponding to the HDR from the outside of the projector 1C, and transmits it to the signal processor 205. Thereafter, the image input IF unit 204 can receive metadata containing information on the HDR. For example, in HDMI2.0a, the information on the HDR in the image data input via INFOFRAME can be obtained.

The signal processor 205 receives the image data input via the cable from the outside of the projector 1 or via the image input IF unit 204 through the wireless communication. The signal processor 205 provides a variety of processes, such as a decode process of an image signal, a keystone correction of an image signal, image processing (e.g., scaling) for the image signal, and a process for superimposing an on-screen display (“OSD”) image on the image signal. The signal processor 205 includes a gradation converter 205a configured to perform a gradation process (gradation conversion process) to the HDR image. The signal processor 205 outputs an image signal to a panel driver 206. The panel driver 206 drives the liquid crystal panel 202a by generating the drive signal corresponding to the received image signal.

A controller 207 includes a microcomputer (processor), and controls each component in the projector 1C in accordance with a control program as a computer program.

A projector light amount acquirer 208 acquires a light amount of the projector 1C. The light amount of the projector 1C can be obtained by storing a lumen (light flux) as a unit usually used to estimate the brightness of the projector 1C, as a setting value for the specification of the projector 1C. A more precise setting value is available by storing a setting value in each projector 1C based on the actual measurement data before the projector 1C is shipped. The light source generally lowers the brightness with working time, and may use a value reflects a change of the light flux after the projector 1C is shipped, based on a relationship between the light source working time period and the light flux deterioration (which is calculated based on the calculation equation and the experimental data). A photo-diode configured to measure leak light may be provided around the light modulator 202 and the projection unit 203, and the value of the light flux may be calculated based on the relationship between the leak light and the light flux (or based on the calculation equation and the experimental data).

The projection plane area acquirer 209 acquires the area (projected area) on the projection plane of the projection image output from the projector 1C. The projection plane area acquirer 209 includes, for example, an unillustrated distance sensor and an unillustrated encoder. The projection plane area acquirer 209 measures a distance from the projector 1C to the projection plane using the distance sensor, and measures a zoom state of the projector 1 using the encoder. The projection plane area acquirer 209 compares the measurement result with the previously stored distance to zoom reference (size reference), and can calculate the area of the projection image. For example, assume that the reference indicates that the distance from the projection plane is 5 m, a zoom state is a wide-angle end, and the projection plane has an area of 100 inches times 100 inches. When the zoom state is maintained and the distance becomes half, the projection plane has an area of 50 inches times 50 inches. In case of the interchangeable lens type projector, the information on the reference can be previously stored in a memory in the interchangeable lens, and the information of the area may be obtained based on information read out of the memory.

A projection plane luminance calculator 207a in the controller 207 calculates the luminance (projection plane luminance) based on the light amount of the projector 1C obtained by the projector light amount acquirer 208 and the projection plane area of the projection image of the projector 1C obtained by the projection plane area acquirer 208. For example, the controller 207 transmits the light amount (projector light flux) of the projector 1C obtained by the projection light amount acquirer 208, and the projection plane area obtained by the projection plane area acquirer 209, to the projection plane luminance calculator 207a. The projection plane luminance calculator 207a calculates the projection plane luminance based on the relational expression between the projector light amount and the projection plane area (projector light amount/projection plane area/Π), and sends it to the controller 207. This relational expression may contain other parameters, such as a reflectance of the projection plane.

A mode setter 210 sets either a stack projection mode or a normal projection mode. The user may set a projection mode, for example, via a user interface, such as GUI. The mode setter 210 may automatically set the stack projection mode by detecting the overlapping projectors (a stack arrangement) with a sensor, characteristic to the stack projection mode.

The communication unit 211 enables communications between the external device and the projector 1C. The communication unit 211 may use, but is not limited to, RS232C, IR remote controller, USB, Ethernet®, WiFi, etc. The signal received by the communication unit 211 enters the controller 207, and is utilized for a variety of controls by the controller 207.

The EDIDROM (storage unit) 212 stores information on EDID (extended display identification data), such as a type and a resolution (display capacity) of the projector 1C, in other words, information on the projector 1C. The EDIDROM 212 is connected to the image output unit, such as a PC and a blue-ray recorder, via the image input IF unit 204. The image output device determines the contents of the image to be output by reading data stored in the EDIDROM 212. The data (EDID) stored in the EDIDROM 212 contains information on the HDR. The source device 3 outputs the image to the projectors 1C and 2C. The source device 3 when connected to the projector, usually reads the display capacity of the projector out of the information (EDID) on the projector stored in the EDIDROM 212 and outputs the image pursuant to the contents of the EDID.

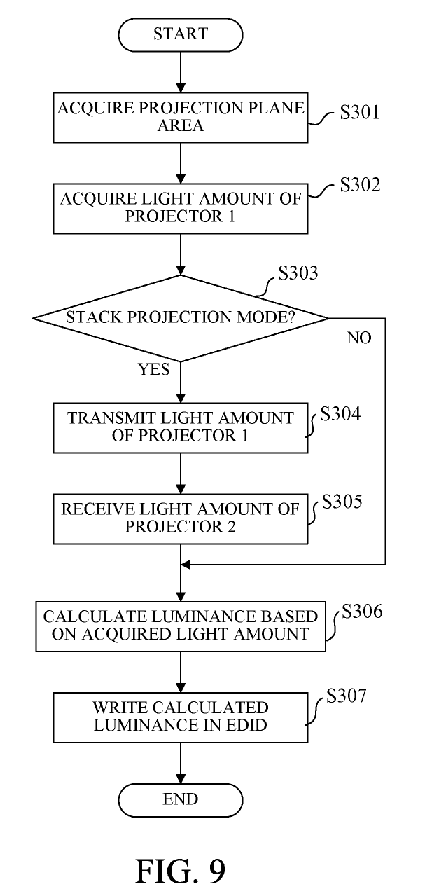

Referring now to FIG. 9, a description will be given of a control method by the projector 1C according to this embodiment (rewriting control of information (EDID) on the projector 1C by calculating the luminance on the stack image). FIG. 9 is a flowchart of the control method according to this embodiment (acquiring of the stack luminance and rewriting of the EDID). Each step in FIG. 9 is executed by each component based on a command from the controller 207 in the projector 1C.

Initially, in the step S301, the controller 207 controls the projection plane area acquirer 209 and acquires the projection plane area (projected area). Next, in the step S302, the controller 207 controls the projector light amount acquirer 208 and acquires the projector light amount (light amount of the projector 1C). Next, in the step S303, the controller 207 receives from the mode setter 210, information of whether the projection mode set by the mode setter 210 is a stack projection mode or not. When the projection mode is set to the stack projection mode, the flow moves to the step S304. When the projection mode is not set to the stack projection mode, the flow moves to the step S306.

In the step S304, the controller 207 transmits the projector light amount obtained in the step S302 to the projector 2C (other projector) set to the stack projection mode via the communication unit 211 similar to the projector 1C. Next, in the step S305, the controller 207 receives the projector light amount (light amount of the projector 2C) from the projector 2C via the communication unit 211. The user may set the light amount of the projector 2C via the user interface.

Next, in the step S306 from the step S303, the controller 207 transmits the light amount of only the projector 1C and the projection plane area to the projection plane luminance calculator 207a. The controller 207 controls the projection plane luminance calculator 207a and obtains the calculated result of the projection plane luminance. In the step S306 from the step S305, the controller 207 transmits the light amounts of the projectors 1C and 2C and the projection plane area to the projection plane luminance calculator 207a. The controller 207 controls the projection plane luminance calculator 207a and obtains the calculation result of the projection plane luminance.

Next, in the step S307, the controller 207 rewrites the contents of the EDIDROM 212 based on the calculated result of the obtained projection plane luminance. In the interface, such as the HDMI, the source device 3 reads the EDID again by usually rewriting the EDID and turning off a hot plug, and by turning on the hot plug after rewriting ends.

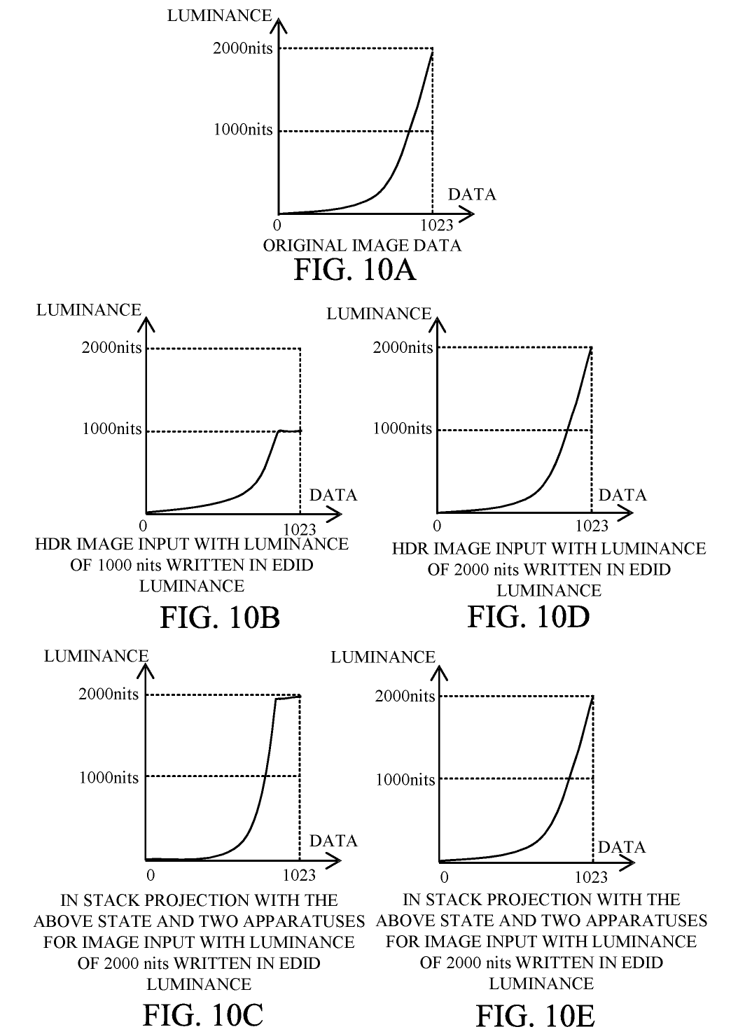

Referring to FIGS. 10A to 10E, a description will be given of a correlation between a luminance (gradation) and data. FIGS. 10A to 10E are graphs illustrating a relationship between the luminance and the image data. FIG. 10A illustrates a relationship between the HDR image (image data corresponding to the HDR) reproduced by the source device 3. The abscissa axis in FIG. 10A denotes a value of the input image data (HDR image data) with values from 0 to 1023 for 10 bits. The ordinate axis in FIG. 10A illustrates the luminance (brightness). This relationship will be referred to as EOTF (electro-optical transfer function), and which relational expression is used for the standard of the input signal is determined. A relational expression referred to as a PQ curve is known as the EOTF for the HDR. The graph in FIG. 10A indicates an input image with a maximum luminance of 2000 nits (cd/m²) for 10 bits, for example. This relational expression is determined by the standard of the input signal, and is usually received as the metadata contained in the input.

The graph in FIG. 10B illustrates the relationship between the luminance and the image data input from the source device 3 to the single projector where the luminance on the projection plane is written as 1000 nits in EDID. The display capacity of the projector is limited to 1000 nits. Thus, the source device 3 rounds the luminance of originally 2000 nits down to 1000 nits and sends the image where the data represents the maximum value of 1023. Since the human eyes are sensitive to the low gradation, the low gradation data is usually maintained and the relationship between the luminance and the high gradation image data is changed. It is merely an example that the source device 3 outputs this data, but the present invention is not limited to this example.

The graph in FIG. 10C illustrates a relationship between the image data and the luminance on the image with the two projectors in the stack projection illustrated in FIG. 10B. The projectors 1C and 2C are used in the stack state and the maximum luminance on the projection plane increases up to 2000 nits, but each projector receives the image data with the maximum luminance of 1000 nits. Hence, when FIG. 10C is compared with FIG. 10A, a shift occurs on the high gradation side and the luminance of 2000 nits is unavailable by the stack of the projectors 1C and 2C.

The graph in FIG. 10D illustrates a relationship between the image data and the luminance input from the source device 3 to the single projector, when the luminance on the projection plane is written as 2000 nits in the EDID. Although the luminance is 1000 nits in the single projector, the source device 3 sends an image equivalent with the original data as a result of that the EDID is rewritten by acquiring the luminance on the image in the stack projection.

The graph in FIG. 10E illustrates a relationship between the image data and the luminance on the projection plane with the two projectors in the stack projection illustrated in FIG. 10D. In order for each projector to receive the image data up to 2000 nits, the image data can be properly reproduced by comparing FIGS. 10A and 10C with each other and the luminance of 2000 nits in the stack state can be utilized.

This embodiment can receive the HDR image suitable for the luminance on the image for the projectors in the stack projection, and the reproducibility of the HDR image can be improved. This embodiment equally treats the operations among the projectors in the stack state, but a plurality of projectors in the stack state may be set to a master projector and a slave projector and the light amount and the luminance may be communicated among them.

### Fifth Embodiment

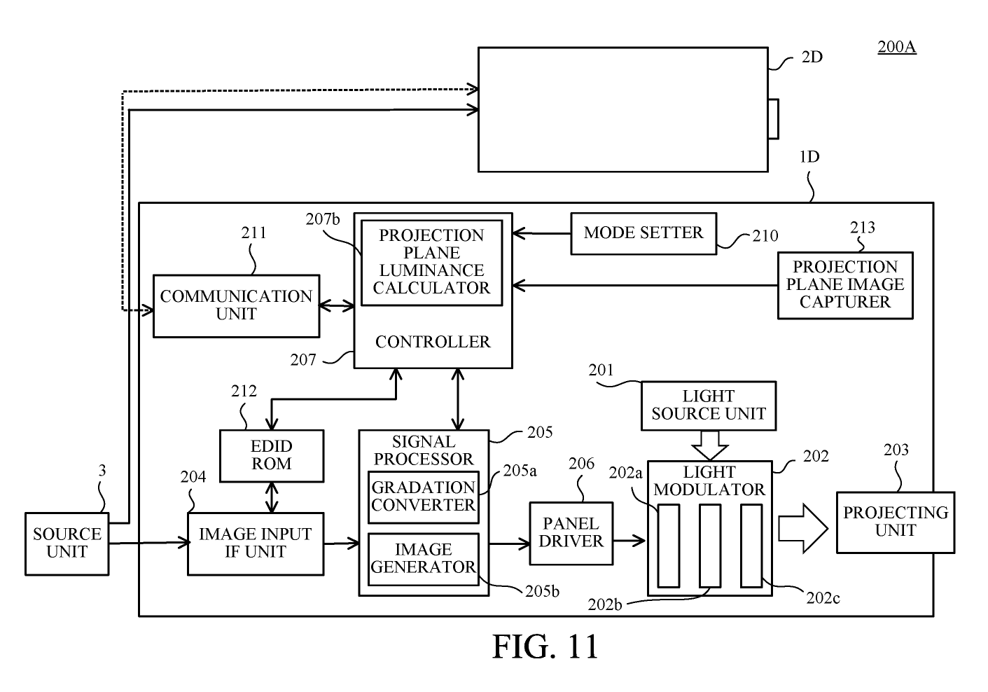

Referring now to FIG. 11, a description will be given of a projector system (projection display system) according to a fifth embodiment of the present invention. FIG. 11 is a block diagram of a projector system 200 according to this embodiment configured to project images in the stack state using a projector 1D (first projector) and a projector 2D (second projector) similar to the projector 1D.

Those elements in this embodiment, which are corresponding elements in the projector 1C in the fourth embodiment (FIG. 8), will be designated by the same reference numerals as those in the fourth embodiment and a description thereof will be omitted. This embodiment calculates the luminance (projection plane luminance) through the projection plane luminance calculator 207a based on the image (projection plane image) captured by the projection plane image capturer 213, and is different from the fourth embodiment in which the projection plane luminance calculator 207a calculates the luminance based on the projection plane area and the projector light amount. In this embodiment, the projection plane image capturer 213 (light amount measuring unit or image capturer) captures an image projected on the projection plane by the projector 1D. This embodiment is not limited to this example, and may use a result measured by another light amount measuring unit, such as a light detector, instead of the projection plane image capturer 213.

The signal processor 205 according to this embodiment includes an image generator 205b in addition to the gradation converter 205a. The image generator 205b generates an image used to determine the light amount when the projection plane image capturer 213 captures an image of a projection plane. The image generator 205b can output a whole white image and capture an image of the projection plane with a maximum light amount, and output the whole black image and capture an image of the projection plane with a minimum light amount.

The projection plane luminance calculator 207b obtains (calculates) the luminance (projection plane luminance) based on the image captured by the projection plane image capturer 213. The projection plane luminance calculator 207b previously stores, for example, correlation data (or a correlation data list) between a data value of the image data obtained by the projection plane image capturer 213 and a luminance value corresponding to the data value. The projection plane luminance calculator 207b can compare the obtained image data with the correlation data list and calculate the luminance value. The correlation data list may use data that reflects the imaging condition of the projection plane image capturer 213, the luminance of the environmental light, etc. When the correlation data can be expressed as a specific expression, the correlation data may be stored as an equation and the luminance may be calculated based on the data value obtained from the image data and the equation.

A mode setter 210a sets a master mode or a slave mode in addition to setting of the stack projection mode. For example, as setting of the stack projection mode, the stack projections are numbered and the smallest number is set to the master mode and another number is set to the slave mode.

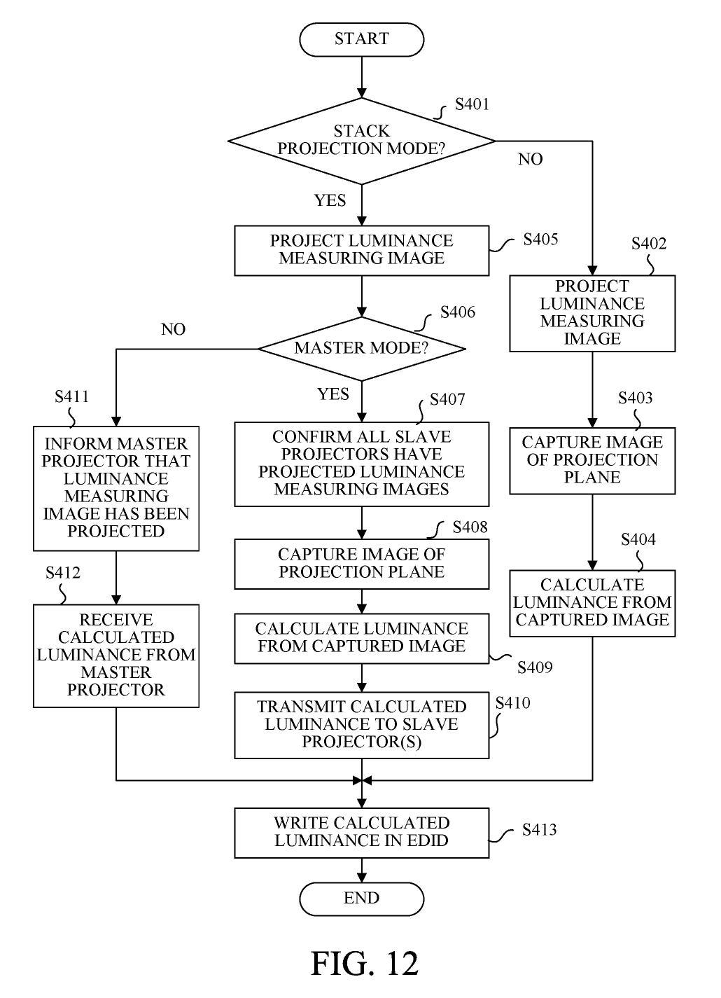

Referring now to FIG. 12, a description will be given of a control method of the projector 1C according to this embodiment (rewriting control of information (EDID) on the projector 1D by calculating the luminance on the stack image). FIG. 12 is a flowchart of the control method according to this embodiment (acquiring of the stack luminance and rewriting of the EDID). Each step in FIG. 12 is executed by each component based on a command from the controller 207 in the projector 1D.

Initially, in the step S401, the controller 207 receives from the mode setter 210, information on whether the projection mode is set to the stack projection mode. When the projection mode is set to the stack projection mode, the flow moves to the step S405. When the projection mode is not set to the stack projection mode, the flow moves to the step S402.

In the step S402, since the projection mode is not set to the stack projection mode, the controller 207 calculates the luminance on the image (luminance of only the projector 1D) in the single projector. The controller 207 (image generator 205) generates a luminance measuring image, and projects this image. Next, in the step S403, the controller 207 (projection plane image capturer 213) captures the projection plane on which the luminance measuring image is projected, and obtains the imaging result. Next, in the step S404, the controller 207 (projection plane luminance calculator 207b) calculates the luminance of the projection plane based on the imaging result obtained from the projection plane image capturer 213. After the luminance of the projection plane is calculated, the flow moves to the step S413.

In the step S405, since the projection mode is set to the stack projection mode, the controller 207 (image generator 205) generates the luminance measuring image, and projects this image. Next, in the step S406, the controller 207 determines whether the master mode or the slave mode is set based on the setting by the mode setter 210. When the master mode is set, the flow moves to the step S407. When the slave mode is set, the flow moves to the step S411.

In the step S407, the controller 207 in the projector set to the master mode, such as the projector 1D, confirms that all slave-mode projectors in the stack projection has projected the luminance measuring image. Next, in the step S408, the controller 207 (projection plane image capturer 213) in the master-mode projector captures a projection plane on which the luminance measuring image is projected, and obtains the imaging result. Next, in the step S409, the controller 207 (projection plane luminance calculator 207b) in the master-mode projector calculates the luminance of the projection plane based on the imaging result obtained from the projection plane image capturer 213. In the step S410, the controller 207 in the master-mode projector transmits the calculated luminance on the projection plane to the slave-mode projector(s), such as the projector 2D.

In the step S411, the controller in the slave-mode projector, such as the projector 2D, confirms that the luminance measuring image has been projected, and sends confirmatory information to the master-mode projector, such as the projector 1D. Next, in the step S412, the controller in the slave-mode projector receives the luminance calculation result that has been calculated in the master-mode projector.

In the step S413, similar to the step S407, the controller 207 rewrites (changes) the contents of the EDIDROM 211 (information on the display capacity of the projector or EDID) based on the projected luminance of the projection plane, which has been obtained.

The above flow can write the luminance on the projection plane in the stack projection, in the EDID. The projector according to this embodiment can receive the HDR image suitable for the luminance in the stack projection, and improve the reproducibility of the HDR image, similar to the fourth embodiment.

In each embodiment, each of the projectors 1C and 1D configured to project the images includes the storage unit (EDIDROM 212), the luminance calculators (projection plane luminance calculators 207a and 207b), and the changer (controller 207). The storage unit stores information on the display capacity of the projector, such as EDID. The luminance calculator calculates the luminance (projection plane luminance) of the projection image obtained in the stack state with a combination of the projector 1C (1D) and the other projector 2C (2D). The changer changes at least part of information stored in the storage unit, based on the luminance calculated by the luminance calculator.

When the projection mode in the projector is set to the stack projection mode used for the combination of the projector and the other projector, the changer changes at least part of information in accordance with the luminance calculated in the stack projection mode. The change may change at least part of information so as to improve the display capacity.

The projector may include an interface unit (image input IF unit 204) configured to inform the external apparatus (source device 3) configured to output the image signal to the projector, of information on the display capacity stored in the storage unit. The projector may project the HDR image corresponding to the image signal input from the external apparatus (image signal corresponding to the HDR) based on the information stored in the storage unit. The projector may include a gradation converter 205a configured to perform gradation processing to the HDR image in accordance with the luminance calculated by the luminance calculator. The projector may include a communication unit 211 configured to communicate with the other projector. The luminance calculator may obtain the light amount of the other projector via the communication unit.

Similar to the projector 1C according to the fourth embodiment, the projector may include the projection plane area acquirer 209 (area acquirer) configured to acquire the projected area of the projection image, and the projector light amount acquirer 208 (light amount acquirer) configured to acquirer the light amount of the projector 1C. The luminance calculator may calculate the luminance of the projected area obtained with a combination of the projector 1C and the other projector 2C based on the area obtained by the area acquirer, the light amount obtained by the light amount acquirer, and the light amount of the other projector 2C.

Similar to the projector 1D according to the fifth embodiment, the projector may include the image generator 205b and the projection plane image capturer 213 (light amount measuring unit). The image generator generates the image used to determine the light amount of the projector 1D. The light amount measuring unit measures the light amount of the projector 1D based on the image generated by the image generator. The luminance calculator calculates the luminance of the projection image obtained with the combination of the projector 1D and the other projector 2D based on the light amount of the projector 1D measured by the light amount measuring unit, and the light amount of the other projector 2D. The light amount measuring unit may be the projection plane image capturer 213 (image capturer) configured to capture an image generated by the image generator.

Each of the fourth and fifth embodiments can provide a projector and a projector system, which can improve the HDR image quality with a simple configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, when the user can set the luminance obtained from the outside, through a menu, the precision of the luminance on the image can be improved. Aside from the luminance measuring unit, the measuring result may be communicated with the projector. The display capacity may be transmitted and received through a component other than the EDID, such as Video over IP. When an image is transmitted through the IP communication, the display capacity may be expressed as a data packet and transmitted to the projector.

Each of the fourth and fifth embodiments discusses the projector system using a plurality of projectors, but the present invention is not limited to these embodiments. Each of the fourth and fifth embodiments is applicable to a configuration that changes at least part of information on the display capacity of the projector based on the luminance of the projection image in accordance with the projected state of one projector. In this case, the changer may change at least part of information stored in the storage unit so as to correspond to the luminance calculated by the luminance calculator (so as to obtain the luminance in the measurement).

This application claims the benefit of Japanese Patent Applications Nos. 2016-087221, filed on Apr. 25, 2016, and 2016-090851, filed on Apr. 28, 2016, each of which is hereby incorporated by reference herein in its entirety.

What is claimed is:

1. A projection display apparatus comprising:
an image inputter configured to input image data;
a signal processor configured to perform a gradation conversion for the image data; and
a luminance calculator configured to calculate a luminance of a projection image in accordance with a projection state,
wherein the signal processor converts a gradation of the image data so as to reduce a difference between a luminance of the projection image and a luminance required by the image data.

2. The projection display apparatus according to claim 1, wherein when the luminance of the projection image that can be projected is lower than a maximum luminance required by the image data, the signal processor converts each gradation of the image data lower than a predetermined gradation into a required luminance, and converts each gradation of the image data equal to or higher than the predetermined gradation into a value lower than the required luminance, and
wherein when the luminance of the projection image that can be projected is equal to or higher than the maximum luminance required by the image data, the signal processor converts the gradation such that the image data has the required luminance.

3. The projection display apparatus according to claim 1, wherein the signal processor converts the gradation such that a maximum gradation value of the image data has the luminance of the projection image that can be projected, when the luminance of the projection image that can be projected is lower than a maximum luminance required by the image data.

4. The projection display apparatus according to claim 1, further comprising a plurality of light source units,
wherein the luminance calculator calculates the luminance of the projection image in accordance with each lighting state of the plurality of light source units.

5. The projection display apparatus according to claim 1, further comprising:
an area acquirer configured to acquire a projected area of the projection image; and
a light amount acquirer configured to acquire a light amount of the projection display apparatus,
wherein the luminance calculator calculates the luminance of the projection image based on the projected area acquired by the area acquirer and the light amount acquired by the light amount acquirer.

6. The projection display apparatus according to claim 1, further comprising:
an image generator configured to generate an image used to determine a light amount of the projection display apparatus; and
a light amount measuring unit configured to measure the light amount of the projection display apparatus based on the image generated by the image generator and projected,
wherein the luminance calculator calculates the luminance of the projection image based on the light amount of the projection display apparatus measured by the light amount measuring unit.

7. The projection display apparatus according to claim 6, wherein the light amount measuring unit includes an image capturer configured to capture the image generated by the image generator and projected.

8. The projection display apparatus according to claim 1, wherein the luminance calculator calculates the luminance of the projection image obtained with a combination of the projection display apparatus and another projection display apparatus.

9. The projection display apparatus according to claim 8, further comprising:
an area acquirer configured to acquire a projected area of the projection image; and
a light amount acquirer configured to acquire a light amount of the projection display apparatus, wherein the luminance calculator calculates the luminance of the projection image obtained with the combination of the projection display apparatus and the other projection display apparatus, based on the area acquired by the area acquirer, the light amount of the projection display apparatus measured by the light amount measuring apparatus, and a light amount of the other projection display apparatus.

10. The projection display apparatus according to claim 8, further comprising:
an image generator configured to generate an image used to determine a light amount of the projection display apparatus; and
a light amount measuring unit configured to measure a light amount of the projection display apparatus based on the image generated by the image generator and projected,
wherein the luminance calculator calculates the luminance of the projection image obtained with the combination of the projection display apparatus and the other projection display apparatus, based on the light amount of the projection display apparatus measured by the light amount measuring apparatus and a light amount of the other projection display apparatus.

11. The projection display apparatus according to claim 10, wherein the light amount measuring unit includes an image capturer configured to capture the image generated by the image generator and projected.

12. The projection display apparatus according to claim 1, wherein the image inputter inputs the image data corresponding to an HDR image.

13. A projection display system configured to project an image using a plurality of projection display apparatuses, comprising:
a first projection display apparatus; and
a second projection display apparatus,
wherein the first projection display apparatus includes:
an image inputter configured to input image data;
a signal processor configured to perform a gradation conversion for the image data; and
a luminance calculator configured to calculate a luminance of a projection image obtained with a combination of the first projection display apparatus and the second projection display apparatus,
wherein the signal processor converts a gradation of the image data so as to reduce a difference between a luminance of the projection image and a luminance required by the image data.

14. A projection display apparatus configured to provide an image, comprising:
a storage unit configured to store information on a display capacity of the projection display apparatus;
a luminance calculator configured to calculate a luminance of a projection image in accordance with a projection state; and
a changer configured to change at least part of the information stored in the storage unit, based on the luminance of the projection image.

15. The projection display apparatus according to claim 14, further comprising an interface unit configured to inform an external unit configured to output an image signal to the projection display apparatus, of information on the display capacity stored in the storage unit.

16. The projection display apparatus according to claim 15, wherein the projection display apparatus projects an HDR image corresponding to the image signal input from the external apparatus, based on the information stored in the storage unit.

17. The projection display apparatus according to claim 16, further comprising a gradation converter configured to convert a gradation of the HDR image in accordance with the luminance calculated by the luminance calculator.

18. The projection display apparatus according to claim 14, wherein the information stored in the storage unit is EDID.

19. The projection display apparatus according to claim 14, wherein the changer changes at least part of the information so as to obtain the luminance calculated by the luminance calculator.

20. The projection display apparatus according to claim 14, further comprising:
an area acquirer configured to acquire a projected area of the projection image; and
a light amount acquirer configured to acquire a light amount of the projection display apparatus,
wherein the luminance calculator calculates the luminance of the projection image, based on the projected area acquired by the area acquirer and the light amount acquired by the light amount acquirer.

21. The projection display apparatus according to claim 14, further comprising:
an image generator configured to generate an image used to determine a light amount of the projection display apparatus; and
a light amount measuring unit configured to measure a light amount of the projection display apparatus based on the image generated by the image generator and projected,
wherein the luminance calculator calculates the luminance of the projection image, based on the light amount of the projection display apparatus measured by the light amount measuring apparatus.

22. The projection display apparatus according to claim 21, wherein the light amount measuring unit includes an image capturer configured to capture the image generated by the image generator and projected.

23. The projection display apparatus according to claim 14, wherein the luminance calculator calculates the luminance of the projection image obtained with a combination of the projection display apparatus and another projection display apparatus.

24. The projection display apparatus according to claim 23, wherein when a projection mode of the projection display apparatus is set to a stack projection mode used with the combination of the projection display apparatus and the other projection display apparatus, the changer changes at least part of the information in accordance with the luminance calculated in the stack projection mode.

25. The projection display apparatus according to claim 24, wherein the changer changes at least part of the information so as to improve the display capacity.

26. The projection display apparatus according to claim 23, further comprising:
an area acquirer configured to acquire a projected area of the projection image; and
a light amount acquirer configured to acquire a light amount of the projection display apparatus,
wherein the luminance calculator calculates the luminance of the projection image obtained with the combination of the projection display apparatus and the other projection display apparatus, based on the projected area acquired by the area acquirer and the light amount acquired by the light amount acquirer.

27. The projection display apparatus according to claim 23, further comprising:
an image generator configured to generate an image used to determine a light amount of the projection display apparatus; and
a light amount measuring unit configured to measure a light amount of the projection display apparatus based on the image generated by the image generator and projected,
wherein the luminance calculator calculates the luminance of the projection image obtained with the combination of the projection display apparatus and the other projection display apparatus, based on the light amount of the projection display apparatus measured by the light amount measuring apparatus and a light amount of the other projection display apparatus.

28. The projection display apparatus according to claim 27, wherein the light amount measuring unit includes an image capturer configured to capture the image generated by the image generator and projected.

29. The projection display apparatus according to claim 23, further comprising a communication unit configured to communicate with the other projection display apparatus,
wherein the luminance calculator obtains the light amount of the other projection display apparatus via the communication unit.

30. A projection display system configured to project an image using a plurality of projection display apparatuses, comprising:
a first projection display apparatus; and
a second projection display apparatus,
wherein the first projection display apparatus includes:
a storage unit configured to store information on a display capacity of the first projection display apparatus;
a luminance calculator configured to calculate a luminance of a projection image obtained with a combination of the first projection display apparatus and the second projection display apparatus; and
a changer configured to change at least part of the information stored in the storage unit, based on a luminance of the projection image.

31. The projection display system according to claim 30, wherein each of the first projection display apparatus and the second projection display apparatus inputs an input image from an external apparatus, and
wherein each of the first projection display apparatus and the second projection display apparatus projects an HDR image corresponding to the image signal input from the external apparatus, based on the information stored in the storage unit.
